(19) United States
(12) Patent Application Publication
(10) Pub. No.: US 2004/0100494 A1
(43) Pub. Date: May 27, 2004

(54) Just in time interoperability assistant

(75) Inventors: Iftach Ragoler, Rehovot (IL); Avi Yaeli, Haifa (IL); Gabi Zodik, Nesher (IL)

Correspondence Address: Stephen C. Kaufman, Intellectual Property Law Dept., IBM Corporation, P. O. Box 218, Yorktown Heights, NY, 10598, US

(73) Assignee: International Business Machines Corporation, Armonk, NY

(21) Appl. No.: 10/306,918

(22) Filed: Nov. 27, 2002

(51) Int. Cl. G09G 5/00

(52) U.S. Cl. 345/745

(57) ABSTRACT

A development tool operable in a development environment. The tool may include tracking means and a processor. The tracking means may be adapted for tracking one or more user interface actions. The processor may be adapted for associating the user interface actions with development information. The development tool may further include notification means for notifying a user of the receipt of development information.

### FIELD OF THE INVENTION

The present invention relates generally to a method and apparatus for software development tools, and in particular to software interoperability development assistants.

### BACKGROUND

It is often a complex and tedious task to search development repositories/search services for software development artifacts. Examples of development repositories/search services may include code repositories, dedicated software development search engines, or configuration management systems. They may reside in the developer's local machine, in the organization infrastructure, over the web, or any place the developer may directly or indirectly access. Examples of software development artifacts may include source code, design documents, code examples, code libraries, frameworks, etc.

In order to perform the above noted searches, the developer must overcome a list of obstacles. The developer must first be aware that such development repositories/search services exist, and understand the type of artifact each repository/service offers. Then he must know how to search in the desired repository/service. He must additionally be familiar with the relevant search interface, and understand the functionality of each relevant repository/service. Lastly, the developer must acquire the training and skills to perform the searches. Since each such repositories/services may have its own search procedure and protocol, acquiring the required search skills is not always a trivial task.

Unlike textual search services that utilize simple keywords queries, many repositories/services require queries with a predefined set of semantic constraints. Some of queries may be mixed with textual based queries. Developers must know how to build such queries. They must have a deep understanding of how to define what they are looking for, and how to “tweak” or refine their searches.

To further complicate the effort, in some cases the developer is looking for information scattered among multiple repositories/services. In these cases, in order to obtain a comprehensive result, the developer will have to search in multiple repositories/services.

Due to these difficulties, in many cases developers will not leverage the functionality that these repositories/services provide, often times resulting in extraneous work functions. For example, in the case of code reuse, the impact of not searching a code repository that contains a reusable component may be rewriting the component from scratch. There is therefore a need for a search assistant for developers.

### SUMMARY

In accordance with one aspect of the present invention, there is now provided a context sensitive intelligent assistant that may be used to assist the developer in his search efforts. The present invention is sometimes known as “a developer's apprentice”. The present invention may comprise the abilities to follow the development of a program or code, define the current stage of development, and determine the context and type of information that may be useful at the current stage. The apprentice may also possess the know-how to invoke queries and retrieve results from various development repositories/search services. The present invention may then provide a visual prompt, on-the-fly suggestions of related resources, development options, or other information, thus providing the developer with just-in-time interoperability.

Via the usage of the present invention, the developer may eliminate the tortuous search task. The developer is relieved of the burden of determining the required material at the appropriate developmental stage, searching for available search repositories, and building the appropriate, complex queries for those search repositories. Where the relevant information may be split among multiple search repositories, the developer's apprentice may gather the information from all repositories, and provide the developer with a single list of results. Alternatively, the present invention may return the results either grouped, or tagged to identify relevant repositories/services.

In accordance with one aspect of the present invention, there is now provided a development tool operable in a development environment. The tool may include tracking means and a processor. The tracking means may be adapted for tracking one or more user interface actions. The processor may be adapted for associating the user interface actions with development information. The development tool may further include notification means for notifying a user of the receipt of development information. Typically the notification may be either a visual or an audio notification.

In some preferred embodiments of the present invention, the processor may include mean for associating the interface actions with a stage of software development. The associating means may further associate the stage of software development with one or more development resources. The processor may further include a module for associating the interface actions with the development information, where the module may include rules, indexes, tables, smart algorithms, learning methodologies, etc.

The interface actions may include either a cursor location, keyboard actions, mouse location, key words, source code, a class declaration, source code commands, usage of lookup tables, contents of chat sessions, mouse events, access to development tools, and so on. The development information may either development tools, class declaration, syntax declaration, import statement, class comment, method comment, method signature, class context, statements written in method, method called outside the class, class signature, field type, comment text, method declaration, package statement, package defined, and so on.

In accordance with one aspect of the present invention, there is now provided a method of retrieving development information in a development environment. The method may include tracking one or more user interface actions, and associating the user interface actions with development information. The method may further include notifying a user of the associated development information. In some preferred embodiments, the method may further include associating the interface actions with a stage of software development, and associating the stage of software development with the development information.

In accordance with one aspect of the present invention, there is now provided a context. The context may include features indicating one or more development information, wherein development information may be associated with one or more user interface actions. The features may include development tools, class declaration, syntax declaration, import statement, class comment, method comment, method signature, class context, statements written in method, method called outside the class, class signature, filed type, comment text, method declaration, package statement, package defined, and features of source code commands, cursor location, usage of lookup tables, contents of chat sessions, language syntax, access to development tools, and so on.

In accordance with one aspect of the present invention, there is now provided a method for forming a context. The method may include tracking one or more interface actions, and associating the interface actions with development information.

In accordance with one aspect of the present invention, there is now provided a system adaptable to retrieve development information. The system may include an integration unit and one or more correlation relationships. The integration unit may form a context including features indicative of development information. The correlational relationships may be used for mapping between the development information and development resources. The correlational relationship may include syntactic correlations and/or textual correlations.

In some embodiments, the system may further include a query generator for forming one or more search queries correlating to the context, and adaptable for the development resources. The system may further include a result processor. The result processor may receive results from the development resources and merge the results into one or more processed results. The merging may follow a weighted ranking scheme, the correlational relationships, or a combination of the weighted ranking scheme and the correlational relationships.

In accordance with one aspect of the present invention, there is now provided a method of retrieving development information. The method may include forming a context includes features indicative of development information, and mapping one or more correlational relationships between the development information and one or more development resources. The method may further include receiving results from the development resources, and merging the results into processed results.

In accordance with one aspect of the present invention, there is now provided a computer program embodied on a computer readable medium. The computer program may include a first code segment operative to track one or more user interface actions, and a second first code segment operative to associate the user interface actions with development information.

In accordance with one aspect of the present invention, there is now provided a second computer program embodied on a computer readable medium. The second computer program may include a first code segment operative to form a context includes features indicative of development information and a second first code segment operative to map one or more correlational relationships between said development information and one or more development resources.

### BRIEF DESCRIPTION

Embodiments of the invention will now be described, by way of example, with reference to the accompanying drawings, in which:

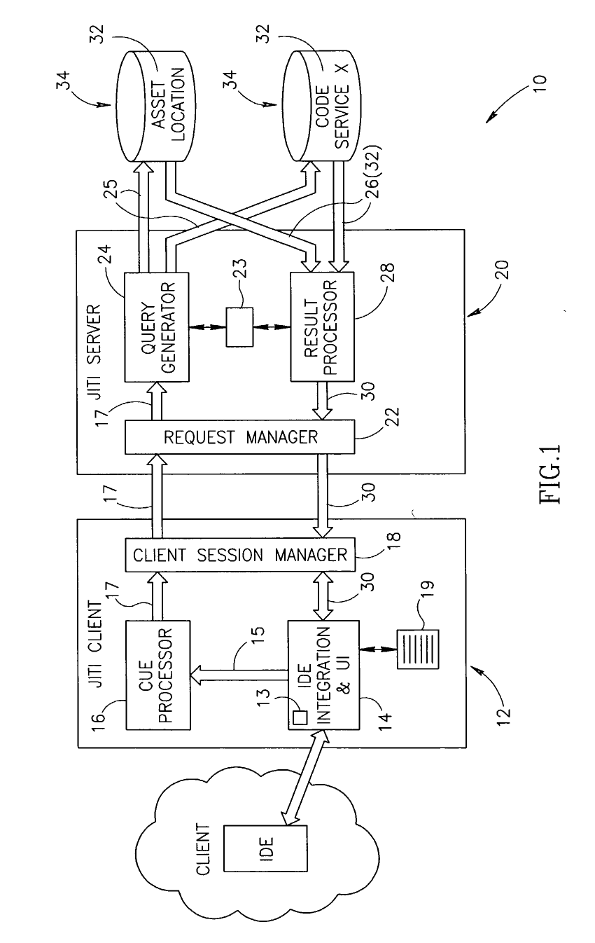

FIG. 1 is a block diagram of a just in time interoperability assistant, constructed and operated in accordance with a preferred embodiment of the present invention;

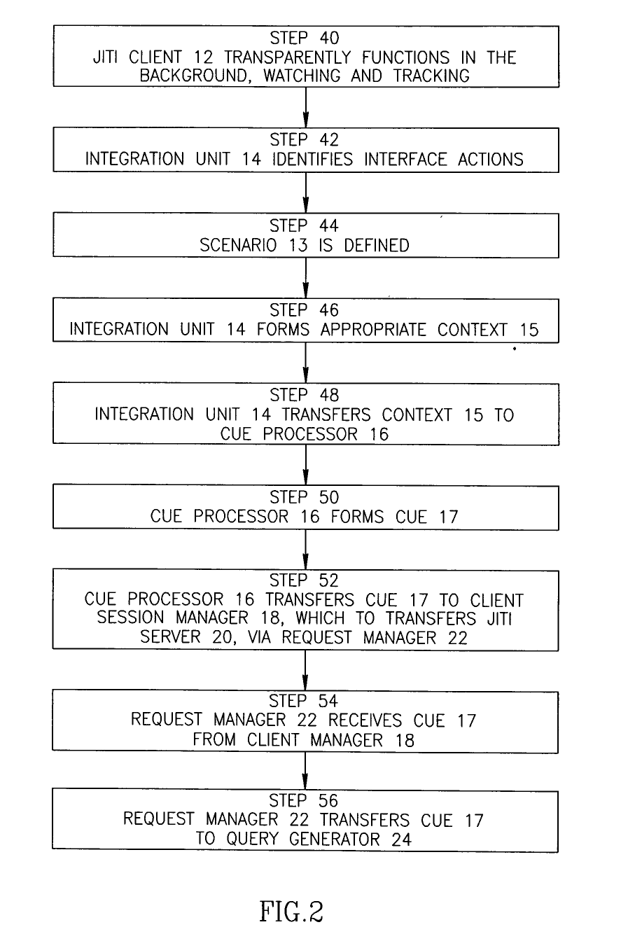

FIG. 2 is a flow chart depicting exemplary resource assistance as operated and provided according to a preferred embodiment of the present invention;

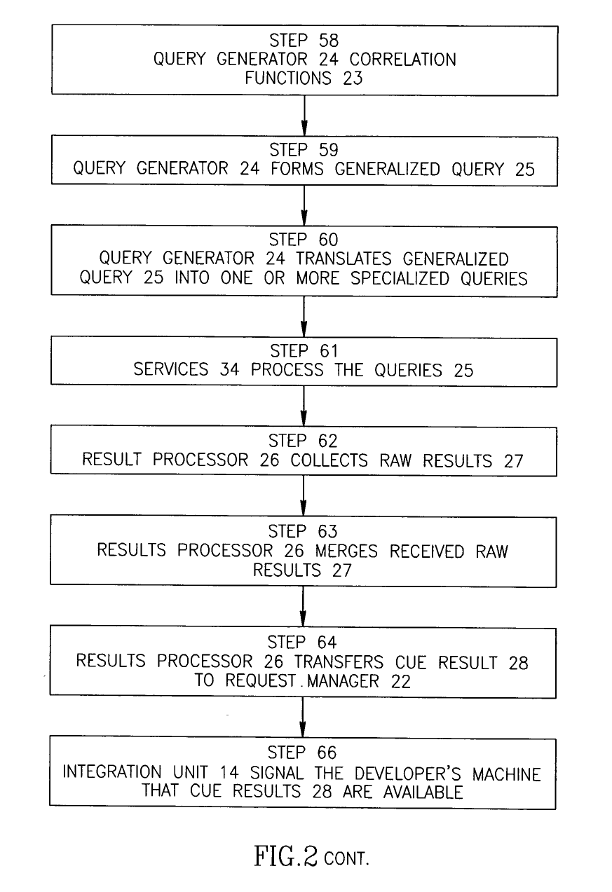

FIG. 3 is an exemplary context, constructed and operated in accordance with a preferred embodiment of the present invention; and

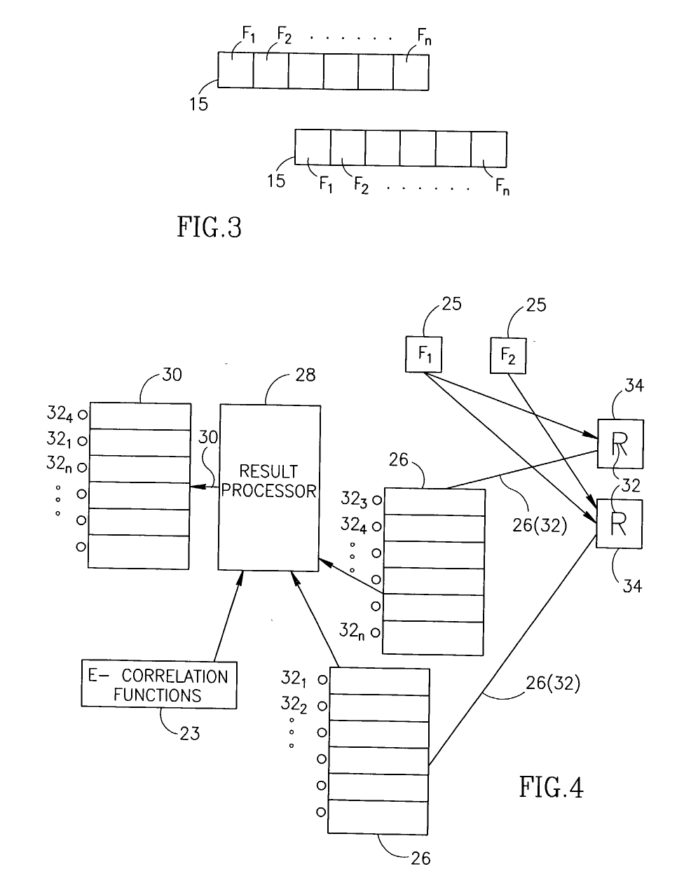

FIG. 4 is an exemplary correlation function constructed and operated in accordance with a preferred embodiment of the present invention.

### DETAILED DESCRIPTION

Reference is now made to FIG. 1, a conceptual illustration of a just in time interoperability assistant (JITI) 10. JITI 10 may be used during software development efforts that typically occur in a development environment, such as in an integrated development environment (IDE). JITI 10 may track a developer's programming process, and assist in finding development artifacts relevant to the current stage program development. In the programming field, JITI 10 may be known as “a programmer's (or developer's) apprentice”.

JITI 10 may be a context sensitive intelligent assistant, comprising the abilities to follow the development of a program or code. JITI 10 may then define the current stage of development, and determine the context and type of information that may be useful at the current stage. In a preferable embodiment, the functioning of JITI 10 may be transparent to the developer.

As to be explained in detail hereinbelow, JITI 10 is aware of the various development search services and/or repositories available. Additionally, JITI 10 may possess the know-how to invoke queries and retrieve results from such. It is noted that herein the terms development search services and repositories may be used interchangeably.

Upon retrieval of the relevant information from the available search repositories, JITI 10 may then provide the developer with just-in-time interoperability. Just-in-time interoperability may be in the form of a visual prompt, on-the-fly suggestions of related resources, development options, or other development artifact information.

In some preferred embodiments, JITI 10 may provide the suggestions in a non-intrusive manner, thus enabling developers to continue their work without being distracted by the JITI 10. Those developers who are interested in suggestions, may obtain and investigate the results. In other preferred embodiments, JITI 10 may provide more interaction/involvement, wherein the level of involvement of prompt and display may be defined by the developer. In still other embodiments, developers may explicitly invoke JITI 10.

Via the usage of JITI 10, the developer may eliminate the tortuous search task. The developer is relieved of the burden of determining the required material at the appropriate developmental stage, searching for available search repositories, and building the appropriate, complex queries for those search repositories. Where the relevant information may be split among multiple search repositories, JITI 10 may gather the information from all repositories, and provide the developer with a single list of results. Alternatively, JITI 10 may provide the results either grouped, or tagged to identify relevant repositories/services.

In one preferred embodiment, a software organization may use JITI 10 to promote/enforce organizational processes, such as promoting reuse and collaboration among development teams.

In other preferred embodiments, JITI 10 may provide user contexts, correlation functions, queries, services, and ranking. JITI 10 may extend its capacity and support additional search repositories, new requirements for user contexts, new correlations, advanced ranking schemes, and so on. Detailed examples of these functions are discussed hereinbelow.

In some embodiments, JITI 10 may define various user contexts for Java and/or other type of candidate resources that may be needed at each context. Alternatively, JITI 10 may define relevancy relationships, known as correlation functions, between user context and candidate resources. Similarly, JITI 10 may provide concept generalization, in the form of cues, queries, and correlations, to support multiple search repositories, each with its own terminology and search capabilities.

Turning now to FIG. 1, JITI 10 may operate within a client/server application/situation, and may comprise a JITI client module 12 in communication with a JITI server module 20. JITI client 12 may comprise a IDE processor integration & user interface unit 14, a cue processor 16, and a client session manager 18. It is noted that although the present embodiment describes integration unit 14 and cue processor 16 as two separate units, it is apparent to those skilled in the art that the functions of elements 14 and 16 could be performed by a single unit, or multiple units, and still be within the principles of the present invention.

JITI server 20 may comprise a request manager 22, a query generator 24, a result processor 28, and may communicate with one or more repositories, such as respositories/services 34.

The JITI client 12 may reside on the same machine that the developer is working on, wherein integration unit 14 may provide the communication and integration within the IDE. Alternatively, JITI client 12 may reside on a machine separate from the developer's machine, however, unit 14 may be linked, or may communicate with the developer's IDE.

Integration unit 14 may track the computer activities as activated by the developer's actions, and identify the program progress or current development stage, known herein as a scenario 13. Scenario 13 may be determined from factors such as user interface actions, keyboard actions, mouse location, key words, source code, cursor location, code development progress, text features, the usage of lookup tables, contents of chat sessions, access to development tools, other development actions, etc. Depending on the current scenario 13, it may desirable for the developer to have access to certain development tools or data. Therefore, in some preferred embodiments scenario 13 may comprise information pertaining to such desired development tools or data. Integration unit 14 may form from scenario 13 an associated context, represented by arrow 15.

Context 15 may comprise features or data indicative of the type of useful development tools or information desired, i.e. in Java, import statements, field types, package statements, etc. Examples of such feature or data may also include user interface activities, cursor location, surrounding text, etc., similar to the factors used in determining scenario 13. It is noted that examples given herein pertain to the Java language, however, the principles of the present invention are equally applicable to other programming languages, models, development methodologies or any other semantic language or text.

In some preferred embodiments, determining scenario 13 is optional. In such embodiments, integration unit 14 may track the developer's user interface actions, such as commands of source code, the cursor location, the usage of lookup tables, etc., identify from the actions one or more potentially desirable development tools or information, and form therefrom context 15. Context 15 may comprise therein the tracked actions and indications of the potentially desirable development tools or information.

It is noted that for each scenarios 13, different resources may be needed; i.e. if the current scenario 13 is implementation of a method body and a specific class type, the associated context 15 may comprise information indicating that the appropriate associated references are code examples of alternatively used class types, thus aiding the developer with additional coding examples.

A detailed example of the association between scenario 13 and context 15 is given hereinbelow in connection with FIGS. 2 and 3.

In some embodiments, integration unit 14 may comprise a module 19 comprising a list of context fits, or associations, between scenario 13 and context 15. As an example, for the scenario 13 of “user in field declaration”, the associated context 15 may comprise inter alia “field type and/or class context”. Module 19 may also comprise rules, indexes, tables, smart algorithms, learning methodologies etc., correlating user interface actions with associated contexts 15.

Integration unit 14 may then transfer one or more contexts 15 to cue processor 16. Context 15 is typically used by the cue processor 16 to build one or more cue requests, represented by arrow 17. As an example, in Java, cue 17 may comprise a package name, imports declaration, class comment, class declaration, requested information type or any other information which may be usable in creation of a query. Cues 17 may be transferred via client session manager 18 to the JITI server 20 for execution.

Client session manager 18 may synchronize between the developer's actions and JITI client 12. Client session manager 18 may also pass cues 17 from JITI client 12 to JITI server 20, via request manager 22. Request manager 22 may support in parallel multiple cues 17 from multiple client modules 12, and may pass these cues 17 onto query generator 24.

Query generator 24 may be aware of the available services/repositories and their associated capabilities. Query generator 24 may additionally possess the know-how to issue requests and obtain results from each service. In order to be aware of such services, query generator 24 may comprise or communicate with a repository listing of the available search services and their associated capabilities. In other preferred embodiments, query generator 24 may be aware of the available search services via predefined knowledge, lookup tables and such.

Query generator 24 may also translate each cue 17 into an appropriate set of queries, represented by arrow 25. Queries 25 may be appropriate for the various available search services. Query generator 24 may then invoke queries 25 against the appropriate search services.

In an embodiment of the present invention, queries 25 may be specific queries tailored for each search services, and/or may be generalized for more than one search service. In order to translate cue 17 to query 25, query generator 24 may use a set of predefined or learned correlation functions 23. Correlation functions 23 may map the relevance between the cues 17 and one or more candidate resources 32. Candidate resources 32 may reside at development search services such as repositories/services 34. Mapping of the relevant candidate resources may be done for each cue 17 separately. Correlation functions 23 may also be used by results processor 28 to rank raw results 26 received from respositories/services 34. A detailed example of correlation functions 23 is given hereinbelow in connection with FIGS. 2 and 4.

Repositories/services 34 may be different types of repositories, such as code services, asset locators, smart repositories, development repositories, etc. It is noted that for purposes of clarity, FIG. 1 displays only 2 repositories, however, it is obvious to those skilled in the art that JITI 10 may communicate with multiple repositories.

Repositories/services 34 may transfer raw results 26 to result processor 28. Raw results 26 may comprise one or more candidate resources 32 that correlate to queries 25. Results processor 28, via a ranking and merging scheme, may merge raw results 26 into a single cue response 30. In alternative embodiments, two or more cue responses 30 may be created. When merging, result processor 28 may take into account query weight, service weight, ranks returned by each service, correlation functions 23, etc. A detailed description of an exemplary ranking scheme is given hereinbelow in connection with FIGS. 2 and 4.

Cue responses 30 may then be transferred back to JITI client 12, which may present them to the developer's machine in a non-intrusive, or intrusive manner. Cue responses 30 may be presented in a visual or audio manner.

Reference is now made to FIG. 2, an example of assistance as provided by JITI 10, constructed and operated according to a preferred embodiment of the present invention. While the present example involves a Java application in the IDE, it is noted that JITI 10 applications are not limited to the present example, however, may additionally encompass other object oriented languages and/or non-object oriented languages, programming languages, development models, and/or development environments, such as J2EE, HTML, .NET, UML, etc.

As noted above, JITI client 12 transparently functions in the background, watching and tracking (step 40) the programs progress via the developer's actions, and defining the current scenario 13. In some embodiments the code may still be “under construction”, as such in order to identify the current scenario 13, integration unit 14 may apply fuzzy parsing over the source code.

In the present example, the current cursor location indicates implementation of a Java class. As such, one of the elements of the current scenario 13 is a class declaration statement, indicating that the next stage is implementation of the class.

package com.ibm.assetlocator.analyzer.java;
import com.ibm.assetlocator.*;
import java.io.*;
/**
* Analyzes a Java resource
*/
public class JavaAnalyzer extends Analyzer {

Integration unit 14 identifies (step 42) that the cursor is at the end of the class declaration, indicating that the class declaration statement is completed, and the next stage is about to be implemented. Furthermore, integration unit 14 identifies that package and import declarations have been entered, and a few class header comments have been provided as well. Scenario 13 may then be defined (step 44) taking into account all these actions.

Depending on the current scenario 13, integration unit 14 may then form (step 46) an appropriate context 15. In the present example, the developer may save considerable time if he can find a reusable class before implementation of the class. Thus, the appropriate context 15 may comprise therein information concerning reusable Java classes in the enterprise.

It is noted that in some preferred embodiments of the present invention, determining scenario 13, step 44, is optional. In such embodiments, integration unit 14 may execute step 42, then using the identified actions, integration unit may identify possible useful resources, and form therefrom context 15 (step 46).

Integration unit 14 transfers (step 48) the context 15 to cue processor 16. Using the data and features in context 15, cue processor 16 forms (step 50) cue 17. Cue 17 may comprise the package name, imports declaration, class comment, class declaration and/or requested information type. Cue processor 16 transfers (step 52) cue 17 to client session manager 18, which transfers the cue 17, via request manager 22, to JITI server 20.

It is noted that while JITI 10 is functioning transparently in the background, the development process may be progressing, and hence, scenario 13 may be changing. By the time JITI client 12 has completed the process from scenario 13 to cue 17, the development process may have progressed to the point where the originating scenario 13 has changed. In this instance, the results to be received in response to cue 17 may no longer be of interest. Toward this end, client session manager 18 may synchronize the actions of the user interface/context with that of JITI client 12. Thus, client session manager 18 may stop cue 17 from being transferred to JITI server 20. If cue 17 has already been transferred to JITI server 20, client session manager 18 may stop the results from being transferred back to JITI client 12.

Request manager 22 may then receive (step 54) cue 17 from client session manager 18, and transfer (step 56) cue 17 to query generator 24.

Query generator 24 may then begin the process of translating the cue 17 request for reusable classes, to a generalized query 25 for reusable classes. Query 25 may thus query classes having similar textual information, e.g., similar class comment, and similar semantic information, e.g., similar inheritance/implementation relationship.

To enable such translation, query generator 24 may use (step 58) correlation functions 23 to determine the relevance between cue 17 and potential candidate resources 32. With the aid of correlation functions 23, query generator 24 may then form (step 59) generalized query request 25. In some instances, more than one service 34 may service queries for reusable classes. As such, query generator 24 may translate (step 60) generalized query request 25 into one or more specialized queries to be invoked against the appropriate respositories/services 34.

The repositories/services 34 may then process (step 61) the requests 25, identifying one or more candidates 32. Result processor 28 may then collect (step 62) raw results 26 from the various repositories/services 34. In the present example, raw results 26 may comprise multiple potential candidates 32 of reuse classes. In a preferred embodiment, results processor 28 may wait a predefined amount of time for raw results 26 to be received from the various respositories/services 34. It is noted that by waiting only a limited time, there may be increased chances that the development progress may still be in same scenario 13 as when the cue 17 was issued.

Once the predetermined waiting time has elapsed, results processor 28 merges (step 63) the received raw results 26 using correlation functions 23. Result processor 28 may use a ranking scheme to merge the raw results 26 into a single ranked cue result 30. Cue results 30 may then comprise a reranking listing of candidates 32. It is noted that in some alternative preferred embodiment, result processor 28 does not merge or process raw results 26, rather, transfers raw results 26 to the next step.

Results processor 28 may then transfer (step 64) cue result 30 to request manager 22, which may then transfer cue result 30 to client session manager 18, for eventual transfer to integration unit 14.

In some instances, upon receipt of cue result 30 from server 20, client session manager 18 is aware that scenario 13 has progressed and that information in cue request 30 is no longer of interest to the developer. In such cases, manager 18 may stop the delivery of cue result 30 to integration unit 14.

Upon receipt of cue results 30, integration unit 14 may then signal (step 66) the developer's machine that cue results 30 are available. The developer may choose to see the accumulated list of potential reuse classes. In some embodiments, each class may be marked with an icon representing the relevancy or correlation of the potential class to the user's scenario 13 and/or context 15. The developer may view the results in other various ways, among them: viewing the candidates source file, list of methods, list of fields, organized according to respositories/services 34, per project and more.

Reference to FIG. 3, a preferred embodiment of context 15, and useful in understand scenario 13 and context 15. For further clarity, in parallel please refer to FIG. 1.

As seen in FIG. 3, context 15 may comprise one or more features F, labeled herein as F₁, F₂, etc. Features F may be any data relevant or useful for retrieving development resources for the developer. As an example, features F may be cursor locations, surrounding text, Java commands, other code commands, web information, etc.

Hereinbelow are examples of scenarios 13 and contexts 15 valid for Java. It is noted that with changes, these examples are applicable to other object oriented languages and non-object Oriented languages. The following examples are not intended to be limiting, and other possible context matches are applicable and fall under the boundaries of this application.

Class declaration: The user interface actions may indicate that the development stage, or scenario 13, is development of the class declaration or any other syntax declaration. Thus, it may be useful to receive information on design/reuse level. Associated context 15 may comprise features F of design/reuse level, and a request for classes with similar functionality. The similarity of the classes can be divided into two main groups: ancestor relationship and textual relation.

1. Ancestor Relationship

Classes extends directly or indirectly with the same class that the user extends.

Classes implement directly or indirectly the interface that the user is implementing.

Both types of classes may need a fully qualified superclass/superinterface, and thus import statements may be useful for the resolution.

2. Textual Relation

Classes in which the current class name is a substring, synonym, etc. or appears in the free text of these classes.

Classes having similar textual information, or any other textual relationships The comments above the class declaration and the class name may assist for the textual related classes search and help refine the family related classes search.

For the development stage or scenario 13 of class declaration, associated context 15 may comprise the features F of imports statements, class comment, class signature.

Method declaration: The user interface actions indicate that the development stage or scenario 13 is defining the method declaration signature for classes having a ancestor relationship. Thus, it may be helpful to know if any of the classes implement the same method, i.e. have the same signature. It is likely that these methods may share similar functionality. The user may like to know the class definition for classes used in the method's signature, and method defined textual relation with the methods comment and name.

Associated context 15 may comprise features F of method comment, method signature, and/or class context.

Method body: The user interface actions indicate that the development stage or scenario 13 is development of the body of a method. Thus, it may be useful to receive information that will technically assist in the coding. Therefore the focus may be on retrieval of other examples of how to do things. Among those examples are classes that invoked a certain method or a constructed certain class, or classes that use similar external data (DB, JNI, other). The best examples may be methods that their functionality is similar to the user's. JITI 10 may therefore consider both the method signature and the class context. Associated context 15 may comprise features F of method signature, statements written in the method, method called outside the class and/or class context.

Field declaration: The user interface actions indicate that the development stage or scenario 13 is writing a new field declaration. Thus, associated context 15 may comprise features F of field type and/or class context.

Javadoc comment: Tthe user interface actions indicate that the development stage or scenario 13 is writing class or method comment. The comment can be used to refine the results for this class or method, if they exist, or construct first query to find similarity for the class or method declaration if they don't exists yet. Depending on the location of the comment, associated context 15 may comprise features F of comment text, class or method declaration.

Import statement: The user interface actions indicate that the development stage or scenario 13 is writing an import statement. Associated context 15 may comprise features F of import statement, package statement.

Package declaration: The user interface actions indicate that the development stage or scenario 13 is writing a package declaration. Associated context 15 may comprise features F of: package defined.

Scrolling along the code or editing the code or comment: The user interface actions indicate that the development stage or scenario 13 is scrolling or editing. For these instances, it may not always be possible to bring results at all times, rather, only when the cursor stops or when the developers explicitly asks for JITI assistance. The features F of associated context 15 may depend on the stopping location.

Herein now is an explanation of correlation functions 23. Please refer again to FIG. 1. In order to bring the developer a set of relevant candidates that reflects cue 17 one or more correlation functions 23 may be defined. Correlation function 23 may map between cue 17 (representing context 15), and candidate 26.

Correlation functions 23 may be divided into two groups: syntactic correlations 23A and textual correlations 23B. Syntactic correlations may be correlations between entities of a program that are based on syntactic relations, such as the abstract syntax tree in Java, i.e. the inheritance relationship. Textual correlations may be textual similarity functions between names in cue 17 and candidates 32. Such textual similarities include precise comparison, linguistic comparisons, synonyms, thesaurus, abbreviations, etc. Each correlation in the JITI terminology may be between a cue 17 and a candidate resource 26.

As an example, in Java the correlations between the following entities are defined as:

1) Correlation between classes—a class in cue 17 may have a correlation with a class in candidate 32 because of syntactic or textual reason.

2) Correlation between methods—a method in cue 17 may have correlation with a method in candidate 32 because of syntactic or textual reason.

3) Correlation between method and class—a method in cue 17 may have correlation with a class in candidate 32 because of syntactic or textual reason.

Below is an example of correlation functions of the class-class correlations defined in Java:

Given two classes q(in cue), c(in candidate), they may be considered correlated if any combination of the following holds:

q ancestor (super class or super interface) is equal (or considered equal) to c ancestor

q features (methods and fields) is related (not necessary exactly matched) with c features

q name have textual correlation with c name

q comments have textual correlation with c comment

q name have textual correlation with c comment

It is noted that with changes, these examples are applicable to other object oriented languages and non-object Oriented languages. The above noted examples is not intended to be limiting, and other possible correlation functions 23 are applicable and fall under the boundaries of this application.

Reference is now made to FIG. 4, a block diagram illustrating an exemplary use of correlation functions 23 as part of a ranking scheme. For clarity, please refer to FIG. 4 in parallel with FIG. 1.

FIG. 4 illustrates queries 25 being transferred to respositories/services 34. Respositories/services 34 identify candidates 32 which correlate to queries 25. As noted above, often more than one candidate 32 may satisfy the query. In such cases, it may be desirable to present the developer with only the most relevant candidates 32, or alternatively, sort candidates 32 by relevance.

Repositories/services 34 may return raw 26 comprising multiple candidates 32. Each raw results 26 may rank candidates 32 as per the internal ranking scheme of the respective respositories/services 34. Reference numerals 32₁, 32₂, 32₃, and so on, represent such a ranking.

Results processor 28 may receive raw results 26, and apply a weighted ranking scheme via correlation factors 23. The results may then be merged, producing cue results 30, with a reranking of candidates 32.

Results processor 28 may use various ranking schemes. Examplatory ranking schemes may give each candidate 32 a rank that may be influenced by

1) the correlations 23 that the candidate 32 has satisfied or

2) the type of repository/service 34 that the candidate 32 was found in, or both.

Each type of repository/service 34 and each type of correlation may be given a predetermined, configured or learned weight. In some embodiments, repository/service 34 may also contribute ranking for correlations in its domain. One option for overall ranking for a candidate 32 may be computed as followed:

RANK (cue 17, candidate 32)=sum_over_all_services 34 [service 34_weight*weight_of_correlations 23_satisfied (cue 17, candidate 32)*rank given_by_service 34 (cue 27, candidate 32)]

It is noted that the above equation is only one possibility, other ranking schemes are possible and included within the principles of this invention. After computing the rank for each candidate 32, results processor 28 may sort the candidates ranks in descending order and returns cue results 30 to JITI client 12 for presentation to the developer.

It will be appreciated by persons skilled in the art that the present invention is not limited by what has been particularly shown and describe herein above. Rather, the scope of the invention may be defined by the claims that follow:

1. A development tool operable in an development environment, the tool comprising:
tracking means for tracking one or more user interface actions; and
a processor for associating said user interface actions with development information.

2. The development tool of claim 1, and further comprising notification means for relaying notification of said associated development information.

3. The development tool of claim 2, wherein said notification is a visual or an audio notification.

4. The development tool of claim 1, wherein said processor comprises:
means for associating said interface actions with a stage of software development, and for associating said stage of software development with said development information.

5. The development tool of claim 1, wherein said interface actions include one or more of the following: a cursor location, keyboard actions, mouse location, key words, source code, a class declaration, source code commands, usage of lookup tables, contents of chat sessions, mouse events, and access to development tools.

6. The development tool of claim 1, wherein said associated development information include one or more of the following: development tools, class declaration, syntax declaration, import statement, class comment, method comment, method signature, class context, statements written in method, method called outside the class, class signature, field type, comment text, method declaration, package statement, and package defined.

7. The development tool of claim 1, wherein said processor comprises:
means for forming a context, said context comprising features indicative of said development information.

8. The development tool of claim 7, wherein said features include one or more of the following: development tools, class declaration, syntax declaration, import statement, class comment, method comment, method signature, class context, statements written in method, method called outside the class, class signature, filed type, comment text, method declaration, package statement, package defined, and features of source code commands, cursor location, usage of lookup tables, contents of chat sessions, language syntax, and access to development tools.

9. The development tool of claim 1, wherein said processor further comprises a module for associating said interface actions with said development information.

10. The development tool of claim 9, wherein said module includes one or more of the following: rules, indexes, tables, smart algorithms, learning methodologies.

11. A method of retrieving development information in a development environment, the method comprising the steps of:
tracking one or more user interface actions; and
associating said user interface actions with development information.

12. The method of claim 11, and further comprising the step of notifying of said associated development information.

13. The method of claim 11, and further comprising the steps of:
associating said interface actions with a stage of software development; and
associating said stage of software development with said development information.

14. A context comprising features indicative of development information, wherein development information is associated with one or more user interface actions.

15. A method for forming a context, the method comprising the steps of:
tracking one or more interface actions; and
associating said interface actions with development information.

16. A system adaptable to retrieve development information, the processor comprising:
an integration unit for forming a context comprising features indicative of development information; and
one or more correlational relationships for mapping between said development information and one or more development resources.

17. The system of claim 16 wherein said correlational relationship include one or more of the following: syntactic correlations and textual correlations.

18. The system of claim 16, and further comprising:
a query generator for forming one or more search queries correlating to said context, said search queries adaptable for said development resources.

19. The system of claim 16, and further comprising:
a result processor to receive one or more results from said development resources and to merge said one or more results into one or more processed results using one of the following schemes: a weighted ranking scheme, said correlational relationships, and combination of said weighted ranking scheme and said correlational relationships.

20. A method of retrieving development information, the method comprising the steps of:
forming a context comprising features indicative of development information; and
mapping one or more correlational relationships between said development information and one or more development resources.

21. The method of claim 20 and further comprising the steps of:
receiving one or more results from said development resources, and
merging said one or more results into one or more processed result using one of the following schemes: a weighted ranking scheme, said correlational relationships, and combination of said weighted ranking scheme and said correlational relationships.

22. A computer program embodied on a computer readable medium, the computer program comprising:
a first code segment operative to track one or more user interface actions; and
a second first code segment operative to associate said user interface actions with development information.

23. A computer program embodied on a computer readable medium, the computer program comprising:
a first code segment operative to form a context comprising features indicative of development information; and
a second first code segment operative to map one or more correlational relationships between said development information and one or more development resources.
